(19) United States
(12) Patent Application Publication
(10) Pub. No.: US 2012/0292799 A1
(43) Pub. Date: Nov. 22, 2012

(54) PATTERN FORMING METHOD AND PATTERN FORMING APPARATUS

(76) Inventor: Daizo Mutoh, Yokohama-shi (JP)

(21) Appl. No.: 13/415,520

(22) Filed: Mar. 8, 2012

(30) Foreign Application Priority Data
May 16, 2011 (JP) 2011-109535

(51) Int. Cl. B29C 59/02; B29C 37/00

(52) U.S. Cl. 264/40.1; 425/135

(57) ABSTRACT

According to one embodiment, a pattern forming method includes: applying a curing resin onto a substrate to be processed; bringing a pattern forming template having concave-convex shaped pattern grooves on the surface into contact with the curing resin, to fill the pattern groove with the curing resin; curing the curing resin; and releasing the pattern forming template from the curing resin, to form a pattern of the curing resin on the substrate to be processed. Further, in the pattern forming method, before application of the curing resin, positional information of a foreign object present on the substrate to be processed is measured and stored, and the foreign object is then removed based on the stored positional information of the foreign object.

### CROSS-REFERENCE TO RELATED APPLICATION

This application is based upon and claims the benefit of priority from prior Japanese Patent Application No. 2011-109535, filed on May 16, 2011, the entire contents of which are incorporated herein by reference.

### FIELD

Embodiments of the present invention relate to a method and an apparatus for manufacturing a semiconductor device, a hard disk and a photoarray.

### BACKGROUND

In a semiconductor device manufacturing process, a hard disk manufacturing process and a photoarray manufacturing process, attention has recently been focused on imprint lithography as a method for forming a fine pattern.

This imprint lithography is a method as follows. A curing resin is applied onto a substrate to be processed, and a pattern forming template, formed with concave-convex shaped pattern grooves on the surface thereof, is brought into contact, to fill the pattern grooves with the curing resin. Thereafter, ultraviolet light is irradiated, or heat is added, to cure the curing resin, and the pattern forming template is then released from the curing resin, to form a pattern of the curing resin on the substrate to be processed.

However, when a foreign object is present on the substrate to be processed at the time of filling with the curing resin, the object may prevent the pattern grooves from being filled with the curing resin, or may damage the pattern forming template. This non-filling with curing resin directly leads to a pattern defect, thus causing a decrease in product yield. Further, the damage of the pattern forming template due to the contact with foreign object will result in generation of a new pattern defect in subsequent imprinting.

### BRIEF DESCRIPTION OF THE DRAWINGS

FIGS. 1A to 1G are views showing a pattern forming method of a first embodiment;

FIG. 2 is a flowchart showing pattern forming methods of first to fourth embodiments;

FIG. 3 is a view showing an imprint device of first to fourth embodiments;

FIGS. 4A to 4E are views showing a pattern forming method of a second embodiment;

FIGS. 5A and 5B are views showing a pattern forming method of a third embodiment; and

FIGS. 6A and 6B are views showing a pattern forming method of a fourth embodiment;

### DETAILED DESCRIPTION

In one embodiment, a pattern forming method includes: applying a curing resin onto a substrate to be processed; bringing a pattern forming template having concave-convex shaped pattern grooves on the surface into contact with the curing resin, to fill the pattern grooves with the curing resin; curing the curing resin; and releasing the pattern forming template from the curing resin, to form a pattern of the curing resin on the substrate to be processed. Further, in the pattern forming method, before application of the curing resin, positional information of a foreign object present on the substrate to be processed is measured and stored, and the foreign object is then removed based on the stored positional information of the foreign object.

Hereinafter, embodiments will be described with reference to the drawings. However, the present invention is not restricted to these embodiments. It is to be noted that a portion in common throughout the drawings is provided with a common reference numeral, and a redundant description thereof will not be repeated. Further, the drawings are schematic views for describing the embodiments and promoting an understanding thereof, and some shapes, dimensions, ratios and the like of the drawings may be different from those of an actual apparatus, but these can be designed and changed as appropriate with reference to the following descriptions and a known technique.

In embodiments described below, descriptions will be made as an example of pattern formation by means of imprint lithography, specifically as an example of the case of applying a photo-curing resin by ink-jetting onto an interlayer insulating film (film to be processed) such as a silicon oxide film formed on a semiconductor substrate (substrate) like silicon substrate, to form a pattern. However, the present invention is not restricted to such embodiments.

### First Embodiment

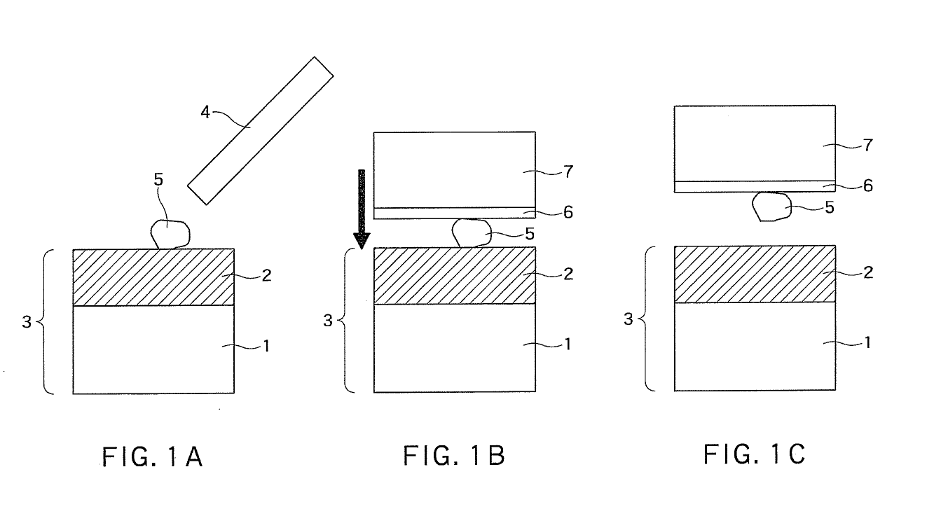

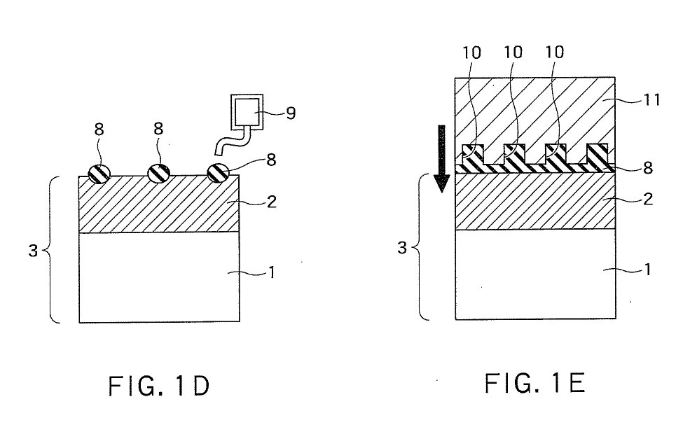

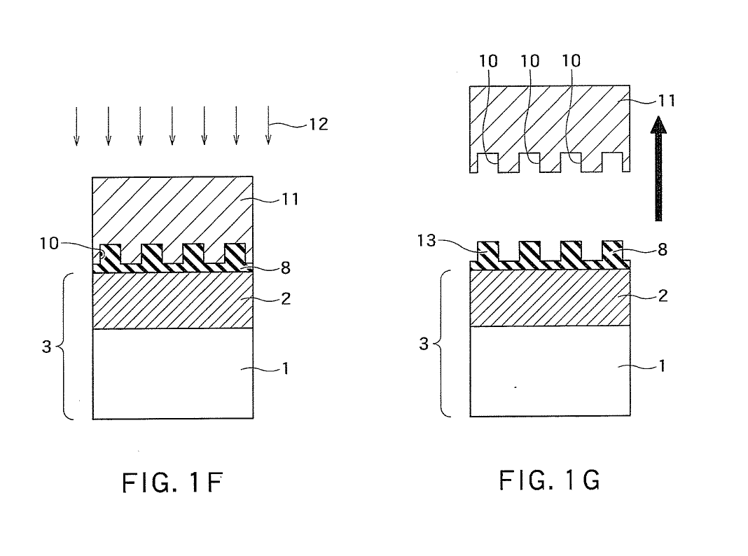

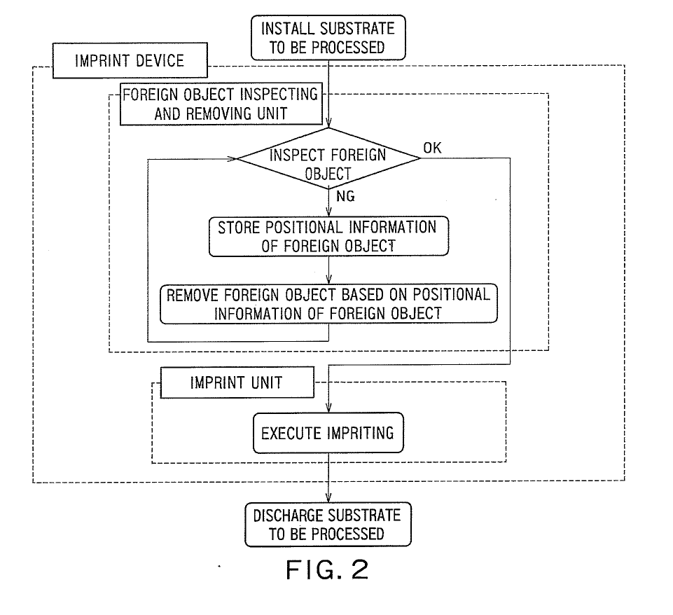

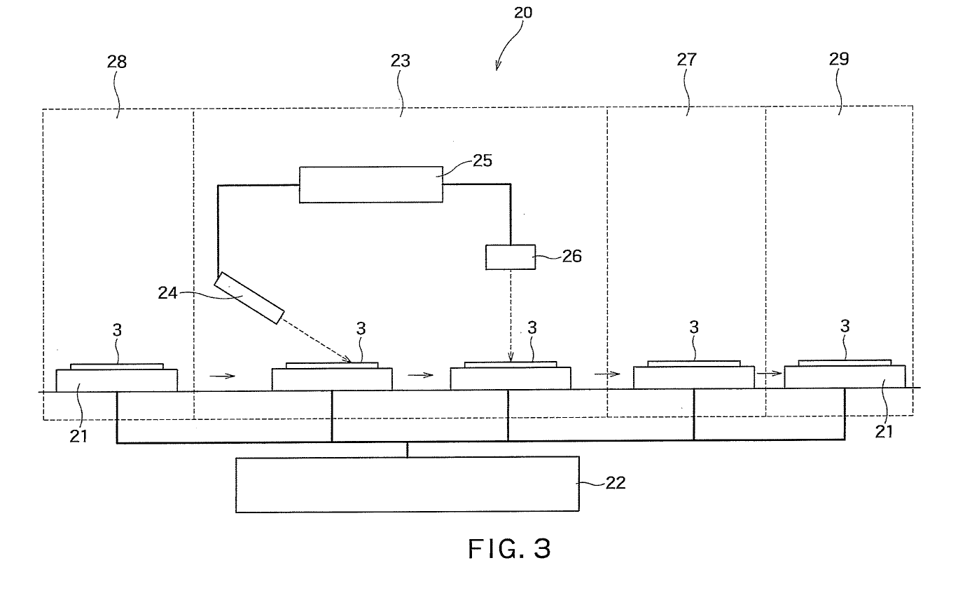

A pattern forming method of the present embodiment will be described using FIGS. 1A to 1G, 2 and 3. FIGS. 1A to 1G are ones schematically showing a pattern forming method of the present embodiment; FIG. 2 is a flowchart showing the pattern forming method of the present embodiment. FIG. 3 is one showing an imprint device of the present embodiment.

As shown in FIG. 1A, a substrate 3 is made up of a substrate 1 and the film 2 to be processed. In a foreign object inspecting and removing unit provided in an imprint device, the surface of a film 2 in a substrate 3 was inspected using an inspection camera 4, to measure a position of a foreign object 5, and the measured position was stored into a storage and control devices (not shown in FIG. 1A) as positional information converted into numerical values. This foreign object, for example, has a size of not smaller than 1 μm. Further, this foreign object 5 is, for example, a foreign object that could not be removed in cleaning in a previous process, or a foreign object attached to the surface of the film 2 to be processed during a period between the previous process and installation of the substrate 3 to be processed into the imprint device for performing pattern formation. Moreover, the method for inspecting the foreign object is not restricted to the method using the inspection camera 4 as above, but may be another method so long as being an optical method. Furthermore, for example, when there is a mark that can be taken as a reference on the substrate 3 to be processed, the position of the foreign object 5 to be stored can be stored as numeric coordinate data with the mark taken as a reference. As another example, a lattice is virtually formed on the surface of the substrate 3 to be processed, to virtually arrange a plurality of squares thereon, and the position of the foreign object 5 to be stored can be converted into numerical values and stored as information as to in which square the foreign object 5 is located.

Then, as shown in FIGS. 1B and 1C, a removal template (foreign object removing device) 7, pasted with an adhesion film 6 and for example having a size of a square of 3 cm, is aligned to the position of the foreign object 5 based on the stored positional information of the foreign object 5, and is subsequently brought into contact with the foreign object 5 to adhere thereto, thereby to remove the foreign object 5. That is, in the present embodiment, removal of the foreign object 5 is not performed throughout the film 2 to be processed, but the position of the foreign object 5 is previously detected and the foreign object 5 is selectively removed based on the positional information. In this manner, it is possible to avoid contamination and destruction of the film 2 to be processed at the time of removing the foreign object 5, and further to reduce the time taken at the time of pattern formation.

It is to be noted that the adhesion film 6 is preferably configured so as to adhere to the foreign object 5 and not to cause contamination and destruction of the surface of the film 2 to be processed. Examples of the adhesion film 6 may include one made of a photo-curing resin 8 for use in pattern formation which will be performed hereafter.

Subsequently, as shown in FIG. 1D, in an imprint unit in the imprint device, a photo-curing resin 8 is applied onto the film 2 to be processed by ink-jetting, specifically by dropping the photo-curing resin 8 from a dispenser 9. The photo-curing resin 8 is, for example, a radical polymerization acrylic curing resin, whose viscosity is, for example, on the order of 10 cP (centipoises).

Next, as shown in FIG. 1E, a pattern forming template 11 having concave-convex shaped pattern grooves 10 on the surface thereof is made adherent to the photo-curing resin 8 on the film 2 to be processed. A press pressure at this time is, for example, 0.1 MPa. Thereby, the pattern groove 10 was filled with the photo-curing resin 8. At this time, since the foreign object 5 on the film 2 to be processed had been removed in the previous process, it was possible to avoid a filling defect which is non-filling of the pattern groove 10 with the photo-curing resin 8 due to the presence of the foreign object 5. The pattern forming template 11 used at this time is made of a material having transparency with respect to UV light 12 that cures the photo-curing resin 8, which is, for example, formed of quartz.

Then, as shown in FIG. 1F, the photo-curing resin 8 is irradiated with UV (Ultra Violet) light 12 from the rear surface of the pattern forming template 11. A wavelength of the UV light 12 at this time is, for example, 365 nm (i-Line), and an irradiated amount of the UV light 12 at this time is, for example, 20 mJ/cm². The photo-curing resin 8 is irradiated with this UV light 12 through the pattern forming template 11, to cross-link polymers in the photo-curing resin 8 so as to cure the photo-curing resin 8.

Subsequently, as shown in FIG. 1G, the pattern forming template 11 was released from the cured photo-curing resin 8, to obtain on the film 2 to be processed a desired pattern 13 made of the photo-curing resin 8 and having a shape formed by reversing concavities and convexities of the pattern groove 10 formed in the pattern forming template 11.

A pattern forming method of the present embodiment is shown by the flowchart of FIG. 2. That is, in the foreign object inspecting and removing unit in the imprint device of the present embodiment, whether the foreign object 5 is present on the substrate 3 to be processed is inspected, and in the case of the foreign object 5 being present, positional information of the foreign object 5 is stored, and further, the foreign object 5 is removed based on the stored position of the foreign object 5. Thereafter, the imprint unit of the imprint device executes imprinting, to form a pattern.

Further, FIG. 3 shows an example of an imprint device 20 used in the present embodiment. The imprint device 20 has a substrate installing unit 28, a foreign object inspecting and removing unit 23, an imprint unit 27, and a substrate discharging unit 29. The substrate 3 to be processed is installed into a substrate installing unit 28 from the previous process. Subsequently, the substrate 3 to be processed is set up on a substrate stage, and then carried by a substrate stage carrying device 22 from substrate installing unit 28 to the imprint unit 27 through the foreign object inspecting and removing unit 23. The foreign object inspecting and removing unit 23 has an inspection camera 24 and a foreign object removing device 26 which are connected with a storage and control device 25, and as described before, by use of these, the foreign object 5 is inspected and removed. In the imprint unit 27, the substrate 3 to be processed where the foreign object 5 has been removed is subjected to imprinting. Thereafter, the substrate 3 to be processed where the pattern has been formed is discharged by the substrate discharging unit 29 to the next process.

As thus described, according to the present embodiment, since imprinting is performed after removal of the foreign object 5 in imprint lithography, it is possible to sufficiently fill the pattern grooves 10 of the pattern forming template 11 with the curing resin 8, so as to reduce a filling defect of the curing resin 8. Further, according to the present embodiment, since imprinting is performed after removal of the foreign object 5, it is possible to avoid chipping of the pattern forming template 11 due to the foreign object 5. This can extend a life of the pattern forming template 11 that costs high. Furthermore, once chipping occurs in part of the pattern forming template 11, when imprinting is then performed using that template, filling defects may occur in many formed patterns due to the chipping, thus leading to reduction in yield. However, according to the present embodiment, it is possible to avoid chipping of the pattern forming template 11, so as to avoid reduction in yield. Further, the position of the foreign object 5 is previously detected, and based on positional information thereof, the foreign object 5 is selectively removed without contaminating and destructing the surface of the film 2 to be processed, whereby it is possible to reduce the time taken at the time of pattern formation, while avoiding contamination and destruction of the film 2 to be processed at the time of removal of the foreign object 5.

Moreover, although the removal template 7 for removing the foreign object 5 is used in the present embodiment, this removal template 7 has a similar configuration to that of the pattern forming template 11, thereby facilitating installation thereof into the imprint device.

### Second Embodiment

The present embodiment is different from the first embodiment in that the foreign object 5 is crushed into small pieces, and then removed. Making the foreign object 5 smaller in this manner can further facilitate removal of the foreign object 5.

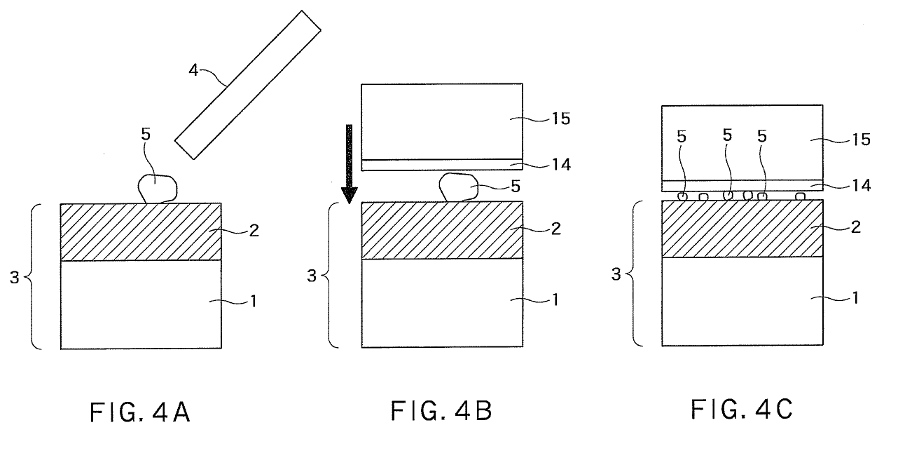

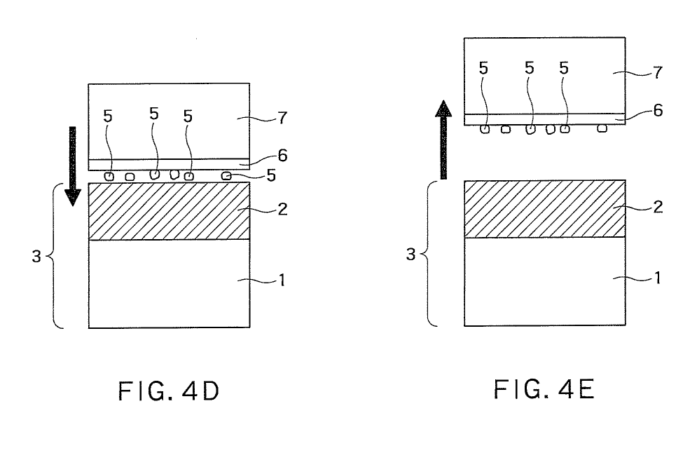

A pattern forming method of the present embodiment will be described using FIGS. 4A to 4E. FIGS. 4A to 4E are ones schematically showing a pattern forming method of the present embodiment. Herein, a detailed description of a portion in common with that of the first embodiment will not be repeated.

First, similarly to the first embodiment, as shown in FIG. 4A, the surface of the film 2 to be processed of the substrate 3 to be processed which is made up of the substrate 1 and the film 2 to be processed is inspected for example by the inspection camera 4, and the position of the foreign object 5 is measured and stored.

Then, as shown in FIGS. 4B and 4C, based on the stored positional information of the foreign object 5, a foreign object crushing template 15 formed with a crush layer 14 capable of crushing the foreign object 5 is pressed onto the foreign object 5 on the film 2 to be processed, to crush the foreign object 5. For example, the foreign object 5 with a size of several tens of micrometers is crushed by the foreign object crushing template 15 into pieces each with a size of not larger than 1 μm. In addition, the crush layer 14 is preferably made of a material having such a degree of hardness as to crush the foreign object 5 and not to destruct the surface of the film 2 to be processed.

Further, as shown in FIGS. 4D and 4E, similarly to the first embodiment, the removal template 7 pasted with the adhesion film 6 is brought into contact with the crushed foreign objects 5 to adhere thereto, thereby to remove the crushed foreign objects 5. It is to be noted that, similarly to the first embodiment, the adhesion film 6 is preferably configured so as to adhere to the foreign object 5 and not to cause contamination and destruction of the surface of the film 2 to be processed.

Thereafter, in order to obtain a desired pattern 13 made of the photo-curing resin 8, similarly to the first embodiment, as shown in FIGS. 1D to 1G, the photo-curing resin 8 is applied onto the film 2 to be processed, the pattern forming template 11 is made to adhere thereto, the photo-curing resin 8 is cured, and the pattern forming template 11 is then released. Since this is thus similar to the first embodiment, a description thereof will not be repeated here.

As thus described, according to the present embodiment, since making the foreign object 5 smaller can further facilitate removal of the foreign object 5 in imprint lithography, it is possible to sufficiently fill the pattern grooves 10 of the pattern forming template 11 with the curing resin 8, so as to reduce a filling defect of the curing resin 8. Moreover, it is possible to avoid chipping of the pattern forming template 11 that occurs due to the foreign object 5, and further to avoid reduction in yield. Then, the position of the foreign object 5 is previously detected, and based on positional information thereof, the foreign object 5 is selectively removed without contaminating and destructing the surface of the film 2 to be processed, whereby it is possible to reduce the time taken at the time of pattern formation, while avoiding contamination and destruction of the film 2 to be processed at the time of removal of the foreign object 5.

Further, in the present embodiment, even when the crushed foreign objects 5 could not be completely removed and the small foreign object 5 is left on the film 2 to be processed, since the foreign object 5 being present on the surface of the film 2 to be processed, onto which the pattern forming template 11 is pressed, is small, it is possible to avoid chipping of the pattern forming template 11 due to the foreign object 5.

Moreover, although the foreign object crushing template 15 for crushing the foreign object 5 is used in the present embodiment, this foreign object crushing template 15 has a similar configuration to that of the pattern forming template 11, thereby facilitating installation thereof into the imprint device.

In addition, the pattern forming method of the second embodiment is shown by the flowchart of FIG. 2 used in the description of the first embodiment. Moreover, the imprint device of the second embodiment is also shown in FIG. 3.

### Third Embodiment

Although the foreign object 5 was made to adhere to the removal template 7 pasted with the adhesion film 6 and was thereby removed in the first embodiment, the present embodiment is different from the first embodiment in that the foreign object 5 is sucked by a suction nozzle 16 and is thereby removed. Removal of the foreign object 5 by sucking in this manner allows the removal without depending on adhesion of the adhesion film 6, and it is therefore possible to make contamination on the substrate 3 to be processed further less as compared with the first embodiment.

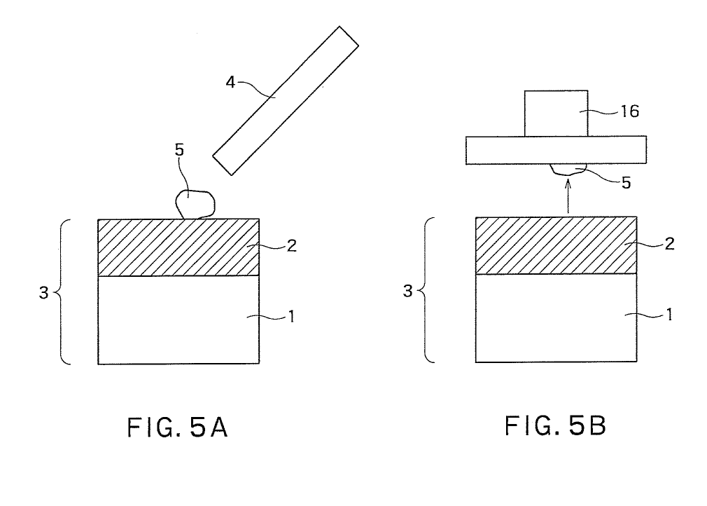

A pattern forming method of the present embodiment will be described using FIGS. 5A and 5B. FIGS. 5A and 5B are ones schematically showing a pattern forming method of the present embodiment. Herein, a detailed description of a portion in common with that of the first embodiment will not be repeated.

First, similarly to the first embodiment, as shown in FIG. 5A, the surface of the film 2 to be processed of the substrate 3 to be processed which is made up of the substrate 1 and the film 2 to be processed is inspected for example by the inspection camera 4, and the position of the foreign object 5 is measured and stored.

Then, as shown in FIG. 5B, the suction nozzle 16 is moved to the position of the foreign object 5 based on the stored positional information of the foreign object 5, to suck the foreign object 5 for removal. That is, in the present embodiment, removal of the foreign object 5 is not performed throughout the film 2 to be processed, but the position of the foreign object 5 is previously detected and the foreign object 5 is selectively removed based on the positional information similarly to the first embodiment. In this manner, it is possible to avoid contamination and destruction of the film 2 to be processed at the time of removing the foreign object 5, and further to reduce the time taken at the time of pattern formation.

It is to be noted that the suction nozzle 16 preferably has sucking power so as to suck the foreign object 5 and not to cause contamination and destruction of the surface of the film 2 to be processed.

Thereafter, in order to obtain a desired pattern 13 made of the photo-curing resin 8, similarly to the first embodiment, as shown in FIGS. 1D to 1G, the photo-curing resin 8 is applied onto the film 2 to be processed, the pattern forming template 11 is made to adhere thereto, the photo-curing resin 8 is cured, and the pattern forming template 11 is then released. Since this is thus similar to the first embodiment, a description thereof will not be repeated here.

As thus described, according to the present embodiment, since the foreign object 5 is sucked and removed by the suction nozzle 16, it is possible to sufficiently fill the pattern grooves 10 of the pattern forming template 11 with the curing resin 8, so as to reduce a filling defect of the curing resin 8. Moreover, it is possible to avoid chipping of the pattern forming template 11 that occurs due to the foreign object 5, so as to avoid reduction in yield. Further, the position of the foreign object 5 is previously detected, and based on positional information thereof, the foreign object 5 is selectively removed without contaminating and destructing the surface of the film 2 to be processed, whereby it is possible to reduce the time taken at the time of pattern formation, while avoiding contamination and destruction of the film 2 to be processed at the time of removing the foreign object 5.

In addition, also in the present embodiment, similarly to the second embodiment, the foreign object crushing template 15 formed with a crush layer 14 having a function to crush a foreign object may be pressed onto the foreign object 5 on the film 2 to be processed, to crush the foreign object 5 and make the foreign object 5 smaller, and the foreign objects 5 may then be removed.

Further, the pattern forming method of the third embodiment is also shown by the flowchart of FIG. 2 used in the description of the first embodiment. Moreover, the imprint device of the third embodiment is also shown in FIG. 3.

### Fourth Embodiment

Although the foreign object 5 was made to adhere to the removal template 7 pasted with the adhesion film 6 and was thereby removed in the first embodiment, the present embodiment is different from the first embodiment in that the foreign object 5 is blown off by an air spray nozzle 17 and is thereby removed. In the present embodiment, since blowing off the foreign object 5 allows removal of the foreign object 5 present in a large area as compared with the first to third embodiments, it is possible to more reliably remove the foreign object 5 even when the accuracy of the positional information of the foreign object 5 measured by the inspection camera or the like is low.

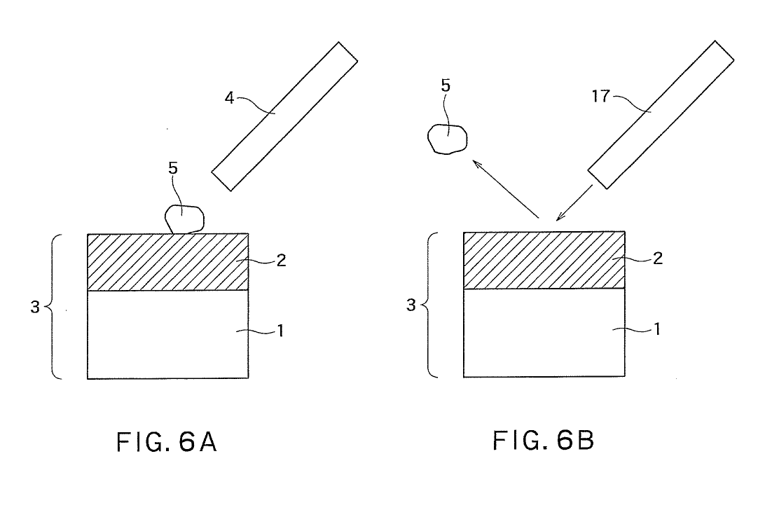

A pattern forming method of the present embodiment will be described using FIGS. 6A and 6B. FIGS. 6A and 6B are ones schematically showing a pattern forming method of the present embodiment. Herein, a detailed description of a portion in common with that of the first embodiment will not be repeated.

First, similarly to the first embodiment, as shown in FIG. 6A, the surface of the film 2 to be processed of the substrate 3 to be processed which is made up of the substrate 1 and the film 2 to be processed is inspected for example by the inspection camera 4, and the position of the foreign object 5 is measured and stored.

Then, as shown in FIG. 6B, an air is sprayed to the foreign object 5 by use of the air spray nozzle 17 based on the stored positional information of the foreign object 5, to blow off the foreign object 5 for removal. That is, in the present embodiment, removal of the foreign object 5 is not performed throughout the film 2 to be processed, but the position of the foreign object 5 is previously detected and the foreign object 5 is selectively removed based on the positional information similarly to the first embodiment. In this manner, it is possible to avoid contamination and destruction of the film 2 to be processed at the time of removing the foreign object 5, and further to reduce the time taken at the time of pattern formation.

It is to be noted that a spray gas, a flow rate thereof and the like have preferably been optimized such that the air spray nozzle 17 blows off the foreign object 5 and does not to cause contamination and destruction of the surface of the film 2 to be processed. Further, after blowing off of the foreign object 5, the surface of the film 2 to be processed of the substrate 3 to be processed may again be inspected by the inspection camera 4.

Thereafter, in order to obtain a desired pattern 13 made of the photo-curing resin 8, similarly to the first embodiment, as shown in FIGS. 1D to 1G, the photo-curing resin 8 is applied onto the film 2 to be processed, the pattern forming template 11 is made to adhere thereto, the photo-curing resin 8 is cured, and the pattern forming template 11 is then released. Since this is thus similar to the first embodiment, a description thereof will not be repeated here.

As thus described, according to the present embodiment, since the foreign object 5 is blown off by the air spray nozzle 17 to remove the foreign object 5, it is possible to sufficiently fill the pattern grooves 10 of the pattern forming template 11 with the curing resin 8, so as to reduce a filling defect of the curing resin 8. Moreover, it is possible to avoid chipping of the pattern forming template 11 that occurs due to the foreign object 5, so as to avoid reduction in yield. Further, the position of the foreign object 5 is previously detected, and based on positional information thereof, the foreign object 5 is selectively removed without contaminating and destructing the surface of the film 2 to be processed, whereby it is possible to reduce the time taken at the time of pattern formation, while avoiding contamination and destruction of the film 2 to be processed at the time of removing the foreign object 5.

In addition, also in the present embodiment, similarly to the second embodiment, the foreign object crushing template 15 formed with a crush layer 14 having a function to crush a foreign object may be pressed onto the foreign object 5 on the film 2 to be processed, to crush the foreign object 5 and make the foreign object 5 smaller, and the foreign objects 5 may then be removed.

Further, the pattern forming method of the fourth embodiment is also shown by the flowchart of FIG. 2 used in the description of the first embodiment. Moreover, the imprint device of the fourth embodiment is also shown in FIG. 3

In the first to fourth embodiments, the substrate 1 may not necessarily be a semiconductor substrate made of silicon, but may be another substrate. Further, it may be one obtained by forming a semiconductor configuration or the like on such a variety of substrates.

Moreover, although it has been described in the above first to fourth embodiments that a radical polymerization acrylic curing resin which is cured by UV light is used as the photo-curing resin 8, the curing resin is not restricted to this, and another resin such as a thermosetting resin may be used. In the case of using the thermosetting resin, heat is applied in place of UV light, to cure the thermosetting resin.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A pattern forming method, comprising:
applying a curing resin onto a substrate to be processed;
bringing a pattern forming template having concave-convex shaped pattern grooves on the surface into contact with the curing resin, to fill the pattern grooves with the curing resin;
curing the curing resin; and
releasing the pattern forming template from the curing resin, to form a pattern of the curing resin on the substrate to be processed,
wherein, before application of the curing resin, positional information of a foreign object present on the substrate to be processed is measured and stored, and the foreign object is then removed based on the stored positional information of the foreign object.

2. The pattern forming method according to claim 1, wherein a removal template having an adhesion film is brought into contact with the foreign object to adhere thereto, thereby to remove the foreign object.

3. The pattern forming method according to claim 2, wherein, before removal of the foreign object, a foreign object crushing template is pressed onto the foreign object, to crush the foreign object.

4. The pattern forming method according to claim 1, wherein the foreign object is sucked by a sucking nozzle, thereby to remove the foreign object.

5. The pattern forming method according to claim 4, wherein, before removal of the foreign object, a foreign object crushing template is pressed onto the foreign object, thereby to crush the foreign object.

6. The pattern forming method according to claim 1, wherein the foreign object is blown off by an air spray nozzle, thereby to remove the foreign object.

7. The pattern forming method according to claim 6, wherein, before removal of the foreign object, a foreign object crushing template is pressed onto the foreign object, thereby to crush the foreign object.

8. A pattern forming apparatus, comprising:
an imprint device forming a pattern made up of a curing resin on a substrate to be processed;
an inspection camera measuring positional information of a foreign object on the substrate to be processed before application of the curing resin;
a storage device storing positional information of the foreign object; and
a foreign object removing device removing the foreign object based on the positional information of the foreign object stored into the storage device.

9. The pattern forming apparatus according to claim 8, wherein the foreign object removing device is provided with a removal template having an adhesion film.

10. The pattern forming apparatus according to claim 9, further comprising a foreign object crushing template that crushes the foreign object.

11. The pattern forming apparatus according to claim 8, wherein the foreign object removing device is provided with a suction nozzle sucking the foreign object.

12. The pattern forming apparatus according to claim 11, further comprising a foreign object crushing template that crushes the foreign object.

13. The pattern forming apparatus according to claim 8, wherein the foreign object removing device is provided with an air spray nozzle.

14. The pattern forming apparatus according to claim 13, further comprising a foreign object crushing template that crushes the foreign object.
